(19) United States
(12) Patent Application Publication
(10) Pub. No.: US 2016/0311496 A1
(43) Pub. Date: Oct. 27, 2016

(54) Stationary Bike Handlebar Riser

(71) Applicant: David Atterbury, Rockton, IL (US)

(72) Inventor: David Atterbury, Rockton, IL (US)

(21) Appl. No.: 15/136,173

(22) Filed: Apr. 22, 2016

Related U.S. Application Data
(60) Provisional application No. 62/151,126, filed on Apr. 22, 2015.

(51) Int. Cl. B62K 21/12; A63B 21/00; A63B 22/06

(52) U.S. Cl. CPC B62K 21/125; A63B 22/0605; A63B 21/4033

(57) ABSTRACT

A stationary bike handlebar riser is provided. The handle bar riser includes a substantially U-shaped riser assembly with a cross bar member, a first riser member, and a second riser member. The first riser member and the second riser member are substantially parallel to one another and each are perpendicular to the cross bar member. Along the ends of the riser members are sleeves that are adapted to receive the upstanding portion of a stationary bike handlebar therein. Each of the sleeves comprises a hollow member, while the riser members can be adjusted for height and angular position relative to the sleeves in certain embodiments. The handlebar riser assembly is useful for allowing a stationary bike user to ride while standing, using the elevated cross bar member for support.

### CROSS REFERENCE TO RELATED APPLICATION

This application claims the benefit of U.S. Provisional Application No. 62/151,126 filed on Apr. 22, 2015. The above identified patent application is herein incorporated by reference in its entirety to provide continuity of disclosure.

### BACKGROUND OF THE INVENTION

### Field of the Invention

The present invention relates to stationary bikes and attachments therefore. More specifically, the present invention relates to a handlebar riser for a stationary bike that allows the rider to user the riser as support while pedaling in a standing position.

Stationary bikes are convenient exercise devices for use in the home or at the gym. These devices allow a user to pedal and expend energy without moving, allowing for exercise without covering long distances or encountering outdoor conditions. Most stationary bikes include a seat, pedals, and a pair of handlebars that the user engages while in the seated, pedaling position. The handlebars include generally include horizontal grip portions and upstanding grip portions to allow the user to hold the bars using a desired hand position. The handlebar grips, however, are most ideal for user while the user is seated and pedaling.

For those that are pedaling intensely or pedaling against strong resistance, the user may wish to stand while pedaling. However, standing on a stationary bike and simultaneously gripping the handlebars can be difficult. The user may have to lean over considerably to reach the lower handlebar grips, which can strain the rider's back. This may force the user to abandon the standing position after a short time. Therefore, the present invention is provided to elevate the handlebars of a stationary bike so a user can be supported while pedaling in a standing position.

In particular, the present invention provides a stationary bike attachment and handlebar riser. The device comprises a cross bar member, a first riser member, and a second riser member. Along the ends of the riser members are sleeves that are adapted to secure over the upstanding ends of a stationary bike handlebar. This enables a user to support his or her body while standing on the pedals, whereby the user can grip or lean against the elevated cross bar member. The riser is substantially U-shaped and in some embodiments is adjustable to change the height of the cross bar and its angle relative to the handlebar of the stationary bike. Overall, the present invention improves the ergonomics of a stationary bike and allows for upright, standing pedaling.

### SUMMARY OF THE INVENTION

The following summary is intended solely for the benefit of the reader and is not intended to be limiting in any way. The present invention provides a new stationary bike handlebar riser wherein the same can be utilized for providing convenience for the user when standing and pedaling on a stationary bike.

It is therefore an object of the present invention to provide a new and improved stationary bike handlebar riser that has all of the advantages of the prior art and none of the disadvantages.

It is another object of the present invention to provide a stationary bike handlebar riser that comprises a substantially U-shaped riser assembly having a cross bar member, a first riser member, and a second riser member.

Another object of the present invention is to provide a stationary bike handlebar riser in which the first riser member and the second riser member are substantially parallel to one another and perpendicular to the cross bar member. The first riser member and the second riser member are separated along a length of the cross bar member and extend from the elevated cross bar member to the handlebars of the stationary bike.

Another object of the present invention is to provide a stationary bike handlebar riser wherein the first riser member and the second riser member each have a first end attached to the cross bar member and a second end. A sleeve is disposed along each second end of the first riser member and the second riser member. The sleeves further comprise hollow members adapted to receive the upstanding handlebars of a stationary bike therethrough.

Another object of the present invention is to provide a stationary bike handlebar riser wherein the sleeves have a length that extends substantially perpendicularly to the first riser member and the second riser member.

Another object of the present invention is to provide a stationary bike handlebar riser embodiment wherein the cross bar member has a first end and a second end, and the first riser member and the second riser member connect to the cross bar member inboard of the first end and second end thereof.

Another object of the present invention is to provide a stationary bike handlebar riser embodiment wherein the first riser member and the second riser member each further comprises a first portion and a second portion. The first portion is slidable relative to the second portion to form a prismatic joint, whereby the distance between the first end and second end of each of the first riser member and the second riser member can be adjusted. To secure the two portions of each riser member, the first portion is securable to the second portion via a pin lock joint therebetween.

Another object of the present invention is to provide a stationary bike handlebar riser embodiment wherein the second end of each of the first riser member and the second riser member rotatably connect to the sleeves via a lockable pin joint. In this embodiment, each of the lockable pin joints further comprises a clevis, a locking pin, a pin joint center, and a plurality of apertures through the second end of each of the first riser member and the second riser member and through the clevis. The locking pin is received through the apertures of the clevis and the second end of the riser members to secure the riser members in an angular position relative to the clevis.

Another object of the present invention is to provide a stationary bike handlebar riser embodiment wherein the first end of each of the first riser member and the second riser member are slidably attached to the cross bar member. In one embodiment, the first end of each of the first riser member and the second riser member further comprises a socket adapted to slidably receive the cross bar member therethrough. The cross bar member has a plurality of aligned apertures therethrough and the sockets further comprise a pair of aligned apertures therethrough and a locking pin. Each of the sockets is affixed to the cross bar member when the locking pin thereof is positioned through a pair of the aligned apertures of the cross bar member and the aligned apertures of the socket.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows the handlebar riser assembly of the present invention in a working state, supported by the upstanding grips of a stationary bike handlebar.

FIG. 2 shows a side view of the handlebar riser assembly of the present invention.

FIG. 3 shows an embodiment of the handlebar riser assembly in which the riser members are length-adjustable.

FIG. 4 shows an embodiment of the handlebar riser assembly in which the riser members are angularly-adjustable relative to the sleeves.

FIG. 5 shows an embodiment of the handlebar riser assembly in which the riser members are slidably-adjustable relative to the cross bar member.

### DETAILED DESCRIPTION OF THE INVENTION

Reference is made herein to the attached drawings. Like reference numerals are used throughout the drawings to depict like or similar elements of the stationary bike handlebar riser of the present invention. For the purposes of presenting a brief and clear description of the present invention, the preferred embodiment will be discussed as used for providing an elevated support for a standing user on a stationary bike. The figures are intended for representative purposes only and should not be considered to be limiting in any respect.

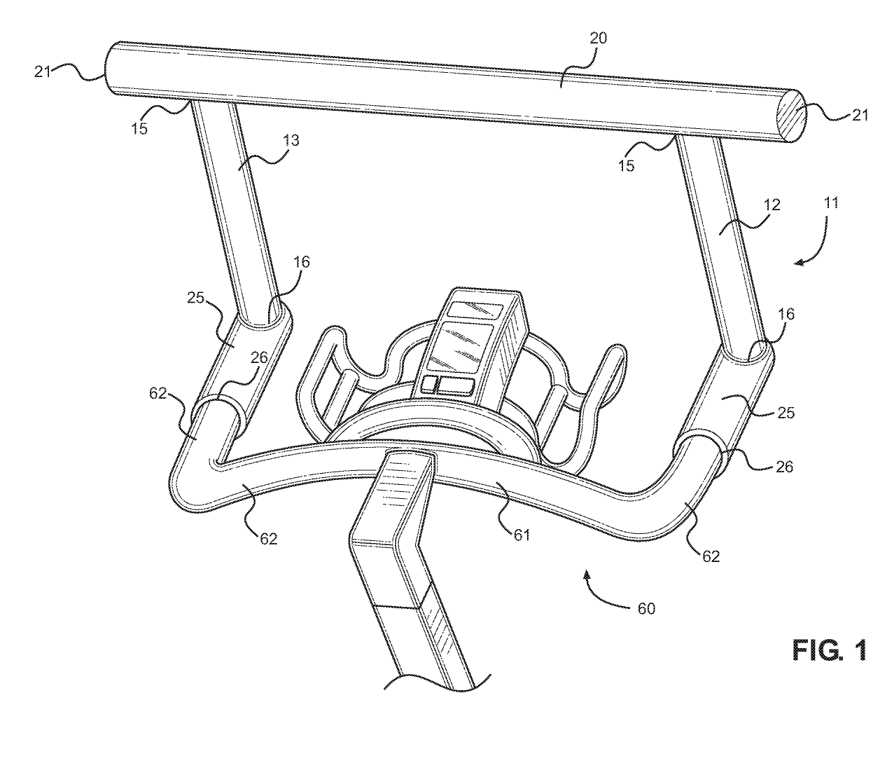

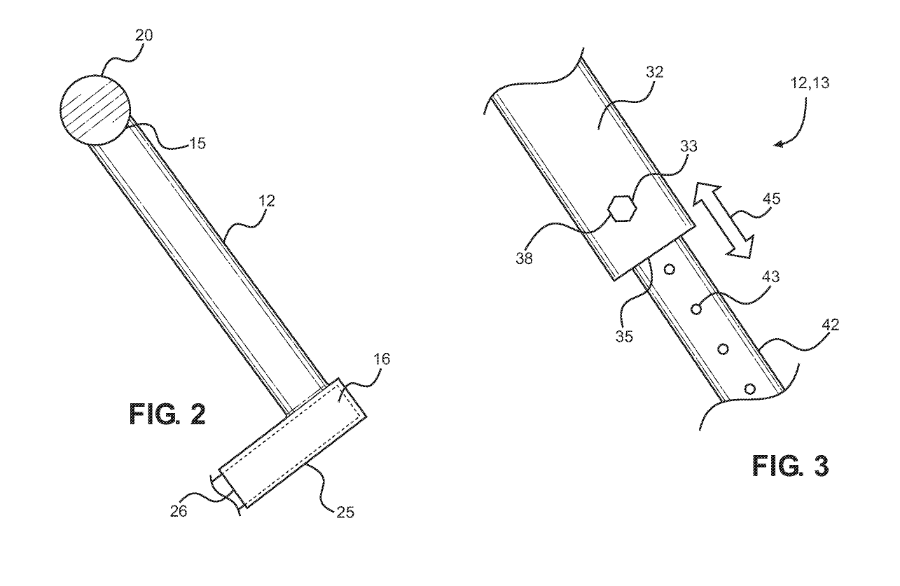

The stationary bike handlebar riser of the present invention is a device that elevates the upper body support of a stationary bike for a user riding the stationary bike in a standing position. Referring to FIGS. 1 and 2, there are shown views of the stationary bike handlebar riser 11 of the present invention and an exemplary configuration of a stationary bike handlebar assembly 60. The handlebar riser of the present invention comprises a substantially U-shaped riser assembly 60 having a cross bar member 20, a first riser member 12, and a second riser member 13. The first riser member 12 and the second riser member 13 are substantially parallel to one another and are used to offset the cross bar member 20 from the handlebars 60 of the stationary bike. In the elevated position, the cross bar member 20 forms a handlebar or body support above the existing stationary bike handlebar that a user can grip or lean upon while riding in a standing position.

The first riser member 12 and the second riser member 13 are also perpendicular to the cross bar member 20, whereby the first riser member 12 and the second riser member 13 are separated by a distance along the length of the cross bar member 20. The separation distance may be set based on the specific stationary bike handlebar 60 the assembly 11 is designed for. In addition, the first riser member 12 and the second riser member 13 may connect to the cross bar member 20 inboard of the ends 21 thereof, allowing the cross bar member 20 have an elongated length that is greater than the existing separation between the handlebars 60 of the stationary bike.

To secure the assembly 11 to the handlebar 60 of the stationary bike, the first riser member 12 and the second riser member 13 each have sleeves 25 that are adapted to receive the ends of stationary bike handlebar 60 therein. The first riser member 12 and the second riser member 13 each has a first end 15 attached to the cross bar member 20 and a second end 16 that is affixed to a sleeve 25. The sleeves 25 are hollow member with open ends 26 that are adapted to receive the handlebars 60 of the stationary bike therethrough.

In particular, the handlebar 60 of the stationary bike generally comprises a horizontal grip portion 61 and an upstanding grip portion 62. The horizontal grip 61 allows for a first hand position while riding, while the upstanding grip 62 allows for a second hand position. This arrangement is common for most stationary bikes. The handlebar riser assembly 11 of the present invention utilizes sleeves 25 that are adapted to receive the upstanding grip portions 26 of the stationary bike handlebar 60 therein. The sleeves 25 slide over the upstanding grip portions 26 and the riser members 12, 13 extend from the sleeves 25. In one embodiment, the sleeves 25 have a length extending substantially perpendicularly to the riser member 12, 13 such that the cross bar member 20 is disposed in a plane perpendicular to the upstanding grip portions 26. In this way, the cross bar member 20 extends between the upstanding grip portions 26 in an elevated position above the upstanding grip portions 62. A user can therefore grip the cross bar member 20 or lean thereagainst while riding in a standing position.

In a preferred configuration, the handlebar riser assembly 11 comprises a rigid configuration, whereby the riser members 12, 13 are welded or otherwise permanently affixed to the cross bar member 20 and the sleeves 25. However, it is also contemplated that the riser members 12, 13 may be adjustable in length and adjustable relative to the cross bar member 20 and the sleeves 25 in some embodiments.

Referring now to FIG. 3, there is shown an embodiment in which the riser members 12, 13 are length adjustable. In this embodiment, the first riser member 12 and the second riser member 13 each further comprises a first slidable portion 32 and a second slidable portion 42. The slidable portions 32, 42 are slidable relative one another to form a prismatic joint 35. The sliding motion is achieved by way of the slidable portions 32, 42 having different cross sectional areas and the first slidable portion 42 being sized to receive the second slidable portion 42 therein (or vice versa). This relative sliding allows the distance between the first end and second end of each riser member 12, 13 to be adjustable 48. This in turn allows the cross bar member to be height adjustable relative to the stationary bike handle bar. The sliding portions 32, 42 are securable to one another using a pin lock joint therebetween. A pin 38 is insertable through a pair of aligned apertures 33, 43 in each slidable portion, whereby one portion has a plurality of aligned rows of apertures 43 and the other portion has a single pair of aligned apertures 33 to receive the pin 38 therethrough.

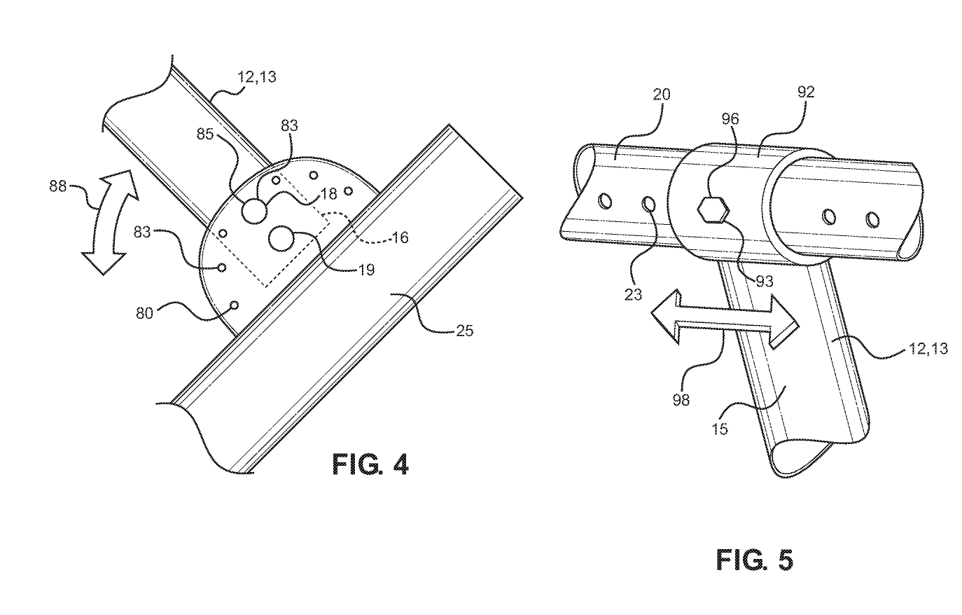

Referring now to FIG. 4, there is shown an embodiment in which the riser members 12, 13 are angularly adjustable 88 relative to the sleeves 25. In this embodiment the second end 16 of each of the riser members 12, 13 rotatably connect to the sleeves 25 via a lockable pin joint 19. The lockable pin 19 is supported on a clevis 80 and allows the riser member 12, 13 to rotate relative to the sleeve 25 such that the sleeve 25 can engage the stationary bike handlebar and the riser member can be angularly positioned to the liking of the user. To secure the riser member to the sleeve in a desired angular position, each clevis 80 further comprises a locking pin 85, a pin joint center 19, and a plurality of aligned apertures 83. A pair of aligned apertures 18 in the second end 16 of the riser members 12, 13 are adapted to align with the pairs of the of apertures 83 on the clevis 80 such that the locking pin 85 can be inserted through the clevis sides and the riser member. This locks the riser member 12, 13 relative to the clevis 80 such that the angle between the riser member 12, 13 and the sleeve 25 is set.

Finally, it is contemplated that the riser members 12, 13 may be slidably attached to the cross bar member 20. Referring now to FIG. 5, there is shown a view of this embodiment. As shown, the first end 15 of each of the riser members 12, 13 are slidable 98 relative to the cross bar member 20. In one embodiment, the first end 15 of each of the riser members 12, 13 further comprise a socket 92 that is adapted to slidably receive the cross bar member 20 therethrough. The cross bar member 20 preferably has a rounded profile, but may also be faceted in some embodiments. The socket 92 conforms to the outer profile of the cross bar member 20 such that the cross bar member 20 is slidable through the socket 92. This allows the riser members 12, 13 to be slidable 98 relative to the cross bar member 20 to account for different stationary bike handlebar configurations.

To secure the riser members 12, 13 of this embodiment to the cross bar member 20, the cross bar member 20 has a plurality of aligned apertures 23 through its cross section. Additionally, each socket 92 further comprises a pair of aligned apertures 93 therethrough and a locking pin 96. The sockets 92 are affixed along the cross bar member 20 when the locking pin 96 thereof is positioned through a pair of the aligned apertures 23 along the cross bar member 20 and through the aligned apertures 93 of the socket 92. This locks the socket 92, and thus the riser member 12, 13, relative to the cross bar member.

Overall and in any embodiment, the cross bar member 20 is positioned above the existing handlebars of the stationary bike. An elevated cross bar member 20 provides a secure balance bar for supporting the weight of a user, allowing the user to stand while pedaling. This provides greater convenience over the existing handlebars. The sleeves 25 of the assembly are slid onto the handlebars of the stationary bike and the user can bear against the cross bar member 20 while standing and pedaling. This may extend a workout or change the method in which the user is pedals bike, offering greater flexibility over the standard handles and reduced back strain.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A stationary bike handlebar riser, comprising:
a substantially U-shaped riser assembly comprising a cross bar member, a first riser member, and a second riser member;
the first riser member and the second riser member being substantially parallel to one another and perpendicular to the cross bar member;
whereby the first riser member and the second riser member are separated along a length of the cross bar member;
the first riser member and the second riser member each having a first end attached to the cross bar member and a second end;
a sleeve disposed along each second end of the first riser member and the second riser member;
the sleeves further comprising a hollow member adapted to receive upstanding handlebars of a stationary bike therethrough.

2) The stationary bike handlebar riser of claim 1, wherein:
the sleeves have a length that extends substantially perpendicularly to the first riser member and the second riser member.

3) The stationary bike handlebar riser of claim 1, wherein:
the cross bar member has a first end and a second end; and
whereby the first riser member and the second riser member connect to the cross bar member inboard of the first end and second end thereof.

4) The stationary bike handlebar riser of claim 1, wherein:
the first riser member and the second riser member each further comprises a first portion and a second portion;
the first portion being slidable relative to the second portion to form a prismatic joint, whereby the distance between the first end and second end of each of the first riser member and the second riser member can be adjusted; and
whereby the first portion is securable to the second portion via a pin lock joint therebetween.

5) The stationary bike handlebar riser of claim 1, wherein:
the second end of each of the first riser member and the second riser member rotatably connect to the sleeves via a lockable pin joint.

6) The stationary bike handlebar riser of claim 5, wherein:
each of the lockable pin joints further comprises a clevis, a locking pin, a pin joint center, and a plurality of apertures through the second end of each of the first riser member and the second riser member and through the clevis.

7) The stationary bike handlebar riser of claim 1, wherein:
the first end of each of the first riser member and the second riser member are slidably attached to the cross bar member.

8) The stationary bike handlebar riser of claim 7, wherein:
the first end of each of the first riser member and the second riser member further comprise a socket adapted to slidably receive the cross bar member therethrough;
wherein the cross bar member has a plurality of aligned apertures therethrough;
wherein the sockets further comprise a pair of aligned apertures therethrough and a locking pin;
wherein each socket is affixed along the cross bar member when the locking pin thereof is positioned through a pair of the aligned apertures of the cross bar member and the aligned apertures of the socket.
